(19) United States
(12) Patent Application Publication
(10) Pub. No.: US 2007/0216400 A1
(43) Pub. Date: Sep. 20, 2007

(54) Magnetic encoder with cover welded to reinforcing ring

(76) Inventor: Toshio Kayao, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 11/714,276

(22) Filed: Mar. 6, 2007

Related U.S. Application Data
(63) Continuation of application No. 11/480,363, filed on Jul. 5, 2006, now abandoned.
Application No. 11/480,363 is a continuation of application No. 10/643,886, filed on Aug. 20, 2003, now abandoned.

(30) Foreign Application Priority Data
Aug. 20, 2002 (JP) 2002-238951

(51) Int. Cl. G01B 7/30

(52) U.S. Cl. 324/207.22

(57) ABSTRACT

A magnetic encoder which is used in a wheel bearing, that forms a pulse train by virtue of a magnetic force, and generates a code, comprises a magnetic ring, a reinforcing ring, and a protecting cover. The magnetic ring is fixed to the reinforcing ring and circumferentially magnetized with alternate S poles and N poles. The protecting cover is made of a non-magnetic material and covers the magnetic ring. A plural number of welds are provided between an end part and/or end parts on a radial inner circumferential side and/or a radial outer circumferential side of the protecting cover, and the reinforcing ring.

This is a continuation application of U.S. patent application Ser. No. 11/480,363, filed Jul. 5, 2006, which is a continuation application of U.S. patent application Ser. No. 10/643,886, filed Aug. 20, 2003, now abandoned.

### BACKGROUND OF THE INVENTION

1. Field of the Invention

The present invention relates to a magnetic encoder having a tough integrated structure, which is strong against impact as well as predominant in terms of productivity and cost.

2. Description of the Related Art

Previously, as a magnetic encoder, taking damage due to foreign material biting and shape distortion into consideration, a magnetic encoder composed of a rubber material having magnetism and abundant elasticity has been mainly used.

Such magnetic encoder is generally formed by mixing a magnetic powder into a rubber material and placing this mixture with a reinforcing ring into a mold, followed by heating, pressing, vulcanizing and adhering. Thereby, a vulcanized rubber ring is fixed on the reinforcing ring. And then, the vulcanized rubber ring is magnetized circumferentially with alternate S poles and N poles.

Here, as a magnetic powder, a magnetic powder of ferrite has generally been adopted. Since a magnetic material composed of a rare earth element is inferior in terms of kneading workability and moldability, and has high cost, it has been said that a magnetic material composed of a rare earth element is not suitable for mixing into a rubber material, and it has not been generally adopted. However, paying attention to magnitude of magnetic force of magnetic material composed of a rare earth element, adaptation of it has recently been studied.

Although a magnetic encoder formed of a rubber material is excellent in terms of moldability, the magnetic encoder cannot remain strong against impact, and while it is used and worked, or during an attaching process, a magnetic encoder formed of a rubber material is damaged in some cases.

Accordingly, a structure in which a surface of a magnetic encoder is covered with a rigid protecting cover has been developed, and put into practice.

In a structure in which a magnetic encoder is covered with a rigid protecting cover, it becomes necessary to attach and integrate the protecting cover to a reinforcing ring constituting a magnetic encoder. For this reason, a manufacturing process is increased, and work is laborious. In addition, for this reason, costs for manufacturing such products are increased.

The aforementioned attachment and integration have generally been performed as follows.

One way is to make, in advance, a protecting cover into a form covering a magnetized magnetic ring, and adhere and fix the protecting cover to a reinforcing ring via an adhesive.

Another way is to make, in advance, a protecting cover into a form covering a magnetized magnetic ring and, at the same time, extend an edge part of the protecting cover. This extended edge part is deformed, caulked and engaged so as to fix the protecting cover to a reinforcing ring.

However, these conventional attaching and integrating methods have the following problems.

When adhering and fixing is performed using an adhesive, in some cases, an adhering force is reduced with time due to denaturation of the adhesive.

In addition, when caulking and engaging are performed to fix a protecting cover to a reinforcing ring, there is a problem with regard to precision of tight attachment to a magnetic encoder. When the aforementioned extended edge part is excessively deformed in order to attain firm fixing, there is a possibility that a magnetized magnetic ring, which is covered by the protecting cover, is deformed and damaged. Conversely, when an edge part of a protecting cover is mildly deformed, stable integration and a strong integrated structure cannot be obtained.

Further, when caulking and engaging are performed to fix a protecting cover to a reinforcing ring, since a part of the protecting cover, for example, an edge part of the protecting cover is enforced to be deformed, there arises easily an influence on other parts during a working process of deformation. For example, even a magnetic pole surface of a magnetized magnetic ring is distorted. When a magnetic pole surface is distorted, a gap degree between a sensor which is disposed opposite to a magnetic encoder is deteriorated, and there arises a disorder in that a measuring precision is reduced.

### SUMMARY OF THE INVENTION

In view of the aforementioned problems of the conventional magnetic encoder, an object of the present invention is to provide a magnetic encoder having a tough integrated structure, and which is strong against impact as well as predominant in terms of productivity and cost.

A magnetic encoder of the present invention is used in a wheel bearing. This magnetic encoder of the present invention forms a pulse train by virtue of a magnetic force, and generates a code, and comprises a magnetic ring, a reinforcing ring, and a protecting cover.

The magnetic ring is fixed to the reinforcing ring and circumferentially magnetized with alternate S poles and N poles.

And, the protecting cover is made of a non-magnetic material and covers the magnetic ring.

Further, in the above-described magnetic encoder of the present invention, the magnetic encoder is characterized in that weld-adhering part(s) (weld(s)) are provided between an end part and/or end parts on a radial inner circumferential side and/or a radial outer circumferential side of the protecting cover, and the reinforcing ring.

In the above description, a magnetic ring can be prepared by forming a ring-like shaped single magnet using a magnetic material such as ferrite or a rare earth element, and circumferentially magnetizing the said ring-like shaped single magnet with alternate S poles and N poles.

Alternatively, a bond magnet, a cast magnet or a sintered magnet may be used as the above described magnetic ring, in which a magnetic powder is mixed into a rubber material or a plastic material to form a ring, and this mixture is circumferentially magnetized with alternate S poles and N poles. In this case, as a magnetic powder, magnetic materials such as ferrite, rare earth elements, MK steel, Alnico and the like can be used.

In the magnetic encoder of the present invention, weld-adhering part(s) (weld(s)) are provided between an end part and/or end parts on a radially inner circumferential side and/or a radially outer circumferential side of a protecting cover, and a reinforcing ring. That is, there are weld(s) which join a reinforcing ring to a protecting cover at an end part and/or end parts on a radially inner circumferential side and/or radially outer circumferential side of the protecting cover.

Accordingly, it is not necessary to apply forced deformation in order to attach or integrate a protecting cover to a reinforcing ring, whereby attachment and an integration process can proceed easily. In addition, after attachment or integration, a distortion does not remain on a magnetic pole surface of a magnetized magnetic ring. Therefore, a gap degree between a magnetic encoder and a sensor, which is disposed opposite to a magnetic encoder, can be retained constant, and a high measurement precision can be exerted.

Further, by adopting weld-adhesion as a fixing method, more stable and firm adhesion, and integration with a reinforcing ring have become possible as compared with adhesion using an adhesive, caulking, and fixing by engagement which have conventionally been performed. In addition, an attachment precision has become higher. Further, execution itself has become easy as compared with a fixing method such as caulking.

In the aforementioned magnetic encoder of the present invention, at an end part and/or end parts on a radially inner circumferential side and/or radially outer circumferential side of a protecting cover, a reinforcing ring may be welded to the cover over an entire circumference of the cover.

Alternatively, in the aforementioned magnetic encoder of the present invention, at an end part and/or end parts on a radially inner circumferential side and/or radially outer circumferential side of a protecting cover, weld-adhesion (welding) may be performed at plural places of 3 to 6 places at a predetermined interval. When weld-adhered (welded) at plural places of 3 to 6 places, sufficient strength and firm integration can be obtained.

In the aforementioned magnetic encoder of the present invention, the aforementioned weld-adhering part (weld) is desirably formed by weld-adhering (welding) an end part and/or end parts on a radially inner circumferential side and/or a radially outer circumferential side of a protecting cover to a reinforcing ring by performing micro-spot welding using laser light. This is so because, by using micro-spot welding using laser light, distortion and thermal influence on parts other than a welded part can be minimized.

In order to minimize distortion and thermal influence on parts other than a welded part, for example, weld-adhesion to a reinforcing ring may be performed using a YAG laser. YAG laser refers to a laser using yttrium-aluminum-garnet crystal containing Nd.

According to the present invention, there can be provided a magnetic encoder which is hardly damaged not only when a magnetic ring having a single magnet as a magnetic material is used, but also when a magnetic ring composed of a rubber material, which is weak to impact and may be damaged while being used and worked, or during an attaching process, is used.

In addition, in the magnetic encoder of the present invention, since a protecting cover is directly weld-adhered to a reinforcing ring, which reinforces a magnetic ring, integrity between the reinforcing ring and the protecting cover can be enhanced, and a tough integrated structure can be obtained.

In addition, by weld-adhesion, a high attachment precision can be realized. Since attachment of a protecting cover at a high precision leads to enhancement of a sensing precision of a magnetic sensor, a measurement precision of a magnetic encoder can be dramatically enhanced.

Further, by weld-adhesion, a manufacturing process becomes easy, and productivity can be enhanced.

Due to these various effects, a lower cost of a high performance magnetic encoder can be realized.

### BRIEF DESCRIPTION OF THE DRAWINGS

FIG. 1 is a partial cross-sectional view of an example in which weld-adhesion between a reinforcing ring and a protecting cover is performed on a radially inner circumferential side of a magnetic encoder;

FIG. 2 is a partially exploded perspective view explaining a state where a magnetic ring is attached to a reinforcing ring;

FIG. 3 is a partial cross-sectional view of an example in which weld-adhesion between a reinforcing ring and a protecting cover is performed on a radially outer circumferential side of a magnetic encoder;

FIG. 4 is a partial cross-sectional view of an embodiment in which weld-adhesion between a reinforcing ring and a protecting cover is performed on a radially outer circumferential side of a magnetic encoder, in an example in which the magnetic encoder of the present invention is adopted in a combination seal structure;

FIG. 5(a) is a partially exploded perspective view showing plural welds; and

FIG. 5(b) is a plan view showing the plural welds.

### DETAILED DESCRIPTION OF THE PREFERRED EMBODIMENTS

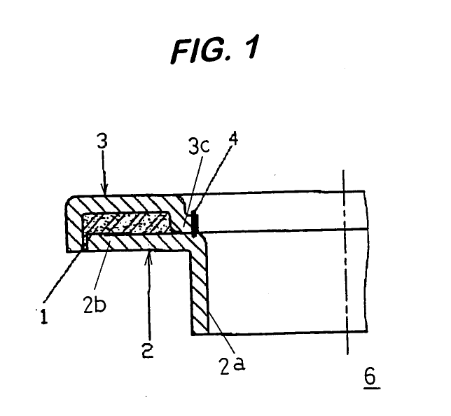

FIG. 1 is a partial cross-sectional view of an example in which weld-adhesion between a reinforcing ring 2 and a protecting cover 3 is performed on a radial inner circumferential side of a magnetic encoder 6.

The magnetic encoder 6 is mounted on a wheel bearing in order to detect a rotational amount. The magnetic encoder 6 forms a pulse train by virtue of a magnetic force, and generates a code.

A sensor (not shown) is disposed opposite to this magnetic encoder 6 (disposed opposite to a magnetic ring 1, in an upper side, in FIG. 1), and a rotational amount is detected.

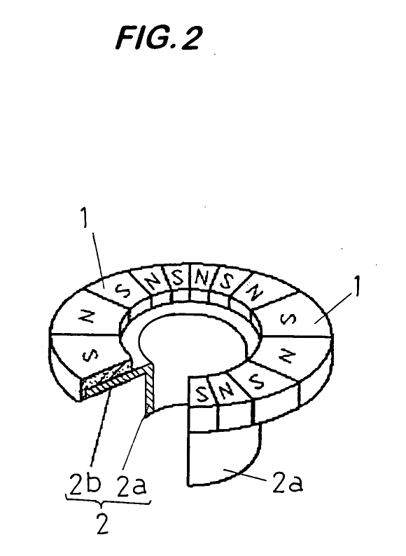

As shown in FIG. 1, the magnetic encoder 6 is comprised of the magnetic ring 1, the reinforcing ring 2, and the protecting cover 3. The magnetic ring 1 is fixed to the reinforcing ring 2, and circumferentially magnetized with alternate S poles and N poles as shown in FIG. 2. The protecting cover 3 is made of a non-magnetic material and covers the magnetic ring 1 as shown in FIG. 1.

In an embodiment shown in FIG. 1, the reinforcing ring 2 is composed of a cylindrical part 2a extending in an axial direction and a flange part 2b extending outwardly in a radial direction from an end part of this cylindrical part 2a. The magnetic ring 1 is fixed to the flange part 2b of this reinforcing ring 2 on an outer surface of flange part 2b in an axial direction.

In the embodiment shown in FIG. 1, the cylindrical part 2a is mounted on an outer circumference of an axial rotary member (not shown).

First, the reinforcing ring 2 is formed using a cold rolled steel plate (SPCC).

On the other hand, a single magnet of ferrite is formed as a ring-like shape, and this ring-like shaped single magnet of ferrite is circumferentially magnetized with alternate S poles and N poles. Thereby, the magnetic ring 1 as a multi-pole magnet is prepared.

As shown in FIG. 2, the magnetic ring 1 is adhered to the flange part 2b of the reinforcing ring 2 using an epoxy series adhesive.

Then, ring-like shaped protecting cover 3 made into a form covering the magnetic ring 1 is prepared using aluminum.

A radial inner circumferential side end part of the protecting cover 3 is bent toward a radial inner circumferential side as expressed by symbol 3c in FIG. 1. And, the protecting cover 3 is attached to the reinforcing ring 2 so that the protecting cover 3 covers the magnetic ring 1.

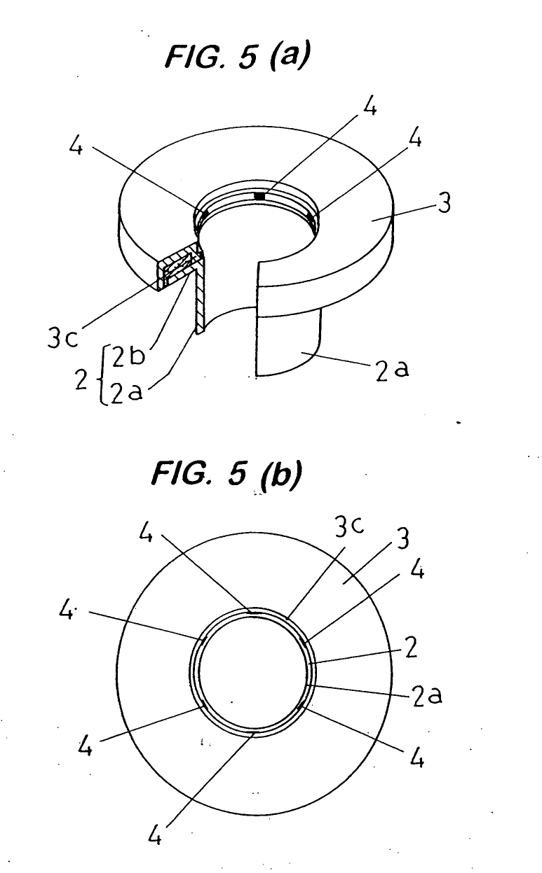

Then, using a YAG laser, an end part of the protecting cover 3 is directly fixed to the reinforcing ring 2 by welding, at a position of symbol 4 in FIG. 1. As shown in FIG. 5(b), weld-adhesion (welding) is performed at six places circumferentially at a predetermined interval. Thereby, the magnetic encoder 6 of the present invention is manufactured.

As a result of various performance tests, it was demonstrated that this constructed magnetic encoder 6 has a tough integrated structure, and is excellent in terms of performance of protecting the magnetic ring 1.

In addition, since manufacturing is easy, productivity is improved and, accompanied therewith, there can be provided a magnetic encoder which is also advantageous in terms of cost.

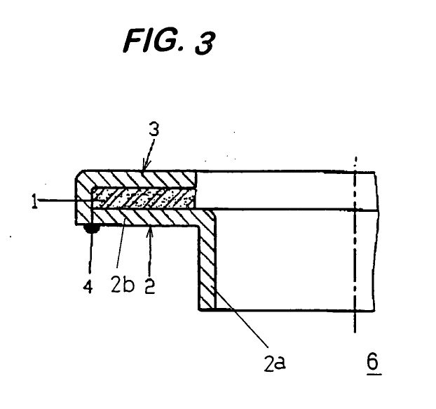

In an embodiment shown in FIG. 3, weld-adhesion (welding) to a reinforcing ring 2 is performed at a radial outer circumferential side end part of a protecting cover 3. In FIG. 3, although it is not show, weld-adhesion is performed at a position of symbol 4, and is performed at five places circumferentially at a predetermined interval.

Since weld-adhesion is not performed on a radially inner circumferential side, a bent part 3c is not provided at an inner circumferential side end part of the protecting cover 3, unlike the embodiment shown in FIG. 1.

Since others are the same as those of the embodiment shown in FIG. 1, explanations thereof will be omitted.

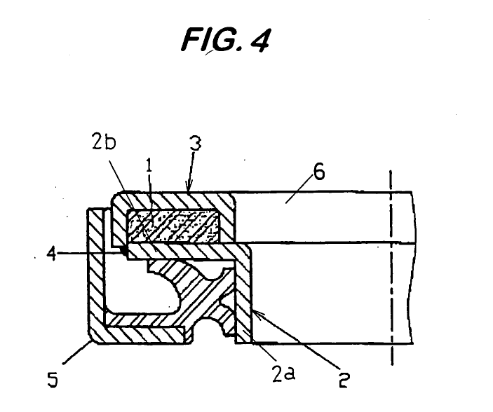

In the embodiment shown in FIGS. 1 and 3, the magnetic encoder 6 was used alone. In an embodiment shown in FIG. 4, magnetic encoder 6 is used as part of a combination seal structure. The magnetic encoder 6 is combined with a sealing member 5. The magnetic encoder 6 and the sealing member 5 relatively rotate. The magnetic encoder 6 is used as an interrupting and sliding material for a part of a sealing material.

In the embodiment shown in FIG. 4, protecting cover 3 is weld-adhered (welding) to reinforcing ring 2 at a radial outer circumferential side end part, as in the embodiment shown in FIG. 3.

In FIG. 4, although it is not shown, weld-adhesion (welding) is performed at a position of symbol 4, and is performed at four places circumferentially at a predetermined interval.

Unlike the embodiment shown in FIG. 3, a radially inner circumferential side end of protecting cover 3 is bent toward an axially inner direction, whereby a radially inner circumferential side end of magnetic ring 1 is covered with the protecting cover 3. Thus, according to the embodiment shown in FIG. 4, performance of protecting the magnetic ring 1 is better than that of the embodiment shown in FIG. 3.

Since other members are the same as those of the embodiment shown in FIG. 1, explanations thereof will be omitted.

In the aforementioned examples, a magnetic ring 1 is formed using a single magnet of ferrite, but a rare earth magnet may be used as the single magnet. As the rare earth magnet, alloys combining a rare earth element such as neodymium and samarium, and cobalt, iron or the like can be used. For example, a neodymium-iron-boron alloy, and a samarium-iron-nitrogen alloy can be used.

In addition, in the above description, upon adhesion of magnetic ring 1 to reinforcing ring 2, an epoxy series adhesive is used, but various adhesives such as cyan series, phenol series, rubber series and urethane series can be used.

Alternatively, magnetic ring 1 may be adhesion-fixed to reinforcing ring 2 without using an adhesive. For example, a magnetic powder of ferrite, or a magnetic powder of a rare earth element is mixed into a rubber material (e.g. nitrile rubber, hydrogenated nitrile rubber, acryl rubber, butyl rubber, fluorine rubber and the like) or a plastic material, and directly vulcanization-molded with the reinforcing ring 2, whereby adhesion fixing can be performed. In this case, after adhesion fixing is performed by vulcanization molding, this member is magnetized circumferentially with alternate S poles and N poles to form a magnetic ring, and then protecting cover 3 is attached. As the aforementioned magnetic powder of a rare earth element, a combination of neodymium (Nd), iron (Fe) and boron (B), or a combination of samarium (Sm), iron(Fe) and nitrogen (N) can be used.

However, as explained in the above examples, when magnetic ring 1 is formed using a single magnet, since performance of a magnetizing process, for circumferentially magnetizing with alternate S poles and N poles to form a magnetic ring, can be conducted in advance and, thereafter, adhesion-fixing may be performed to reinforcing ring 2 using an adhesive, advantages in terms of attachment workability can be realized.

In the above examples, reinforcing ring 2 is formed of a cold rolled steel (SPCC), but a plate composed of a magnetic material such as SUS430 or the like can be used. In any event, when a magnetic material is used as reinforcing ring 2, since a magnetic field can be widened, and a magnetic force from magnetic encoder 6 can be increased, this is advantageous.

In the above examples, aluminum was adopted as a non-magnetic material for forming protecting cover 3, but a plastic and a non-magnetic austenitic stainless steel, for example, SUS304 and SUS301 can be used.

In the above examples, welding between protecting cover 3 and reinforcing ring 2 is performed at 4 to 6 places in a circumferential direction, but since it is enough as far as firm integration is realized, welding may be performed at plural places, for example, at 3 to 6 places.

In addition, taking distortion and thermal influence on parts other than welding parts into consideration, welding is conducted by performing YAG laser welding, but as far as distortion and thermal influence on the parts other than welding parts can be minimized, conventionally known welding methods such as micro-spot welding using other laser light can be used.

In the above examples, an axial rotary member (not shown) is present on a radially inner side of reinforcing ring 2, and the reinforcing ring 2 is attached to an outer circumference of the rotary member. It is natural that the magnetic encoder 6 of the present invention can also be used when a rotary member is present on a radially outer side of reinforcing ring 2, and the reinforcing ring 2 is attached to an inner circumference of the rotary member.

In the foregoing, preferable embodiments of the present invention have been explained by referring to attached drawings, but the present invention is not limited by such embodiments, and can be changed into various forms in terms of technical scope which is grasped from the claims.

What is claimed:

1. A magnetic encoder to be used in a wheel bearing, for forming a pulse train by virtue of a magnetic force and generating a code, comprising:
a magnetic ring circumferentially magnetized with alternate S poles and N poles;
a reinforcing ring fixed to said magnetic ring; and
a non-magnetic protective cover covering said magnetic ring and welded to said reinforcing ring.

2. The magnetic encoder according to claim 1, wherein
said non-magnetic protective cover is welded to said reinforcing ring via one of
(i) welds positioned along an inner circumference of said non-magnetic protective cover,
(ii) welds positioned along an outer circumference of said non-magnetic protective cover, and
(iii) welds positioned along an inner circumference of said non-magnetic protective cover, and welds positioned along an outer circumference of said non-magnetic protective cover.

3. The magnetic encoder according to claim 2, wherein
said welds comprise micro-spot welds produced by a laser.

4. The magnetic encoder according to claim 3, wherein
said micro-spot welds produced by a laser comprise micro-spot welds produced by a YAG laser.

5. The magnetic encoder according to claim 2, wherein
said welds comprise welds produced by a YAG laser.

6. The magnetic encoder according to claim 1, wherein said non-magnetic protective cover is welded to said reinforcing ring via micro-spot welds produced by a laser.

7. The magnetic encoder according to claim 6, wherein
said micro-spot welds produced by a laser comprise micro-spot welds produced by a YAG laser.

8. The magnetic encoder according to claim 1, wherein said non-magnetic protective cover is welded to said reinforcing ring by using YAG laser.

9. The magnetic encoder according to claim 1, wherein
said non-magnetic protective cover is welded to said reinforcing ring via one of
(i) a weld extending along an entire inner circumference of said non-magnetic protective cover,
(ii) a weld extending along an entire outer circumference of said non-magnetic protective cover, and
(iii) a weld extending along an entire inner circumference of said non-magnetic protective cover, and a weld extending along an entire outer circumference of said non-magnetic protective cover.

10. The magnetic encoder according to claim 9, wherein
each said weld comprises a weld produced by a laser.

11. The magnetic encoder according to claim 10, wherein p1 said weld produced by a laser comprises a weld produced by a YAG laser.
